(19) United States
(12) Patent Application Publication
(10) Pub. No.: US 2019/0039951 A1
(43) Pub. Date: Feb. 7, 2019

(54) CONSTRUCTION MATERIAL WITH AN ADMIXTURE OF FLOTATION TAILINGS AND METHOD FOR ITS PREPARATION

(71) Applicant: IPANTERM SP Z O.O., Wroclaw (PL)

(72) Inventors: Piotr PSUJA, Wroclaw (PL); Wieslaw STREK, Bielany Wroclawskie (PL); Dariusz HRENIAK, Wroclaw (PL)

(73) Assignee: IPANTERM SP Z O.O., Wroclaw (PL)

(21) Appl. No.: 16/063,517

(22) PCT Filed: Mar. 17, 2016
(86) PCT No.: PCT/PL2016/050008

§ 371 Date: Jun. 18, 2018

(30) Foreign Application Priority Data
Dec. 22, 2015 (PL) P.415472

(51) Int. Cl. C04B 18/12; C04B 28/00; C04B 18/14; C04B 14/06; C04B 40/00

(52) U.S. Cl. CPC C04B 18/12; C04B 28/008; C04B 40/006; C04B 14/06; C04B 40/0082; C04B 18/146

(57) ABSTRACT

The object of the invention is a construction material containing water glass, fumed silica, ground sand and post-industrial waste material, characterised in that the post-industrial waste material constitutes dried flotation tailings with a content of 19.67-57.24% of SiO₂; 11.87-24.85% of CaO; 4.23-6.19% of MgO and 2.35-4.17% of Al₂O₃, and also the object of the invention is a method for preparing the construction material.

The object of the invention is a construction material with an admixture of flotation tailings and a method for its preparation.

Flotation tailings, resulting from the process of mining and processing of metal ores, constitute waste materials difficult to utilise. Typically, flotation tailings are finely ground waste rock which contains residual amounts of metals.

In the prior art, different concepts of managing flotation tailings are indicated, including the use of waste as a filler of bituminous mixtures in road construction or for the manufacture of construction materials.

In the application PL388764, a method for the preparation of thermal insulation materials with the use of fumed silica, sputtered post-industrial waste or mineral dust is disclosed.

Although there are methods for managing flotation tailings, there is still a need to be able to utilise flotation tailings on a massive scale out of concern for the future ecological consequences of storing large quantities of flotation tailings.

The aim of the present invention is to provide a construction material with an admixture of flotation tailings having good thermal insulation properties.

The object of the invention is a construction material containing water, water glass, fumed silica, ground sand and post-industrial waste material, characterised in that the post-industrial waste material constitutes dried flotation tailings with a content of 19.67-57.24% of SiO₂; 11.87-24.85% of CaO; 4.23-6.19% of MgO and 2.35-4.17% of Al₂O₃.

In one of the preferred embodiments of the invention, in the construction material according to the invention, the post-industrial waste material is constituted by waste L with a content of SiO₂ of 57.24%, CaO of 11.87%, MgO of 4.23%, Al₂O₃ of 4.17%; or P with a content of SiO₂ of 19.67%, CaO of 24.85%, MgO of 6.19%, Al₂O₃ of 3.25% or R with a content of SiO₂ of 53.27%, CaO of 13.88%, MgO of 5.35%, Al₂O₃ of 3.84% or a mixture thereof at a mass ratio of 8:1:1 through 1:8:1 to 1:1:8, preferably 6:2:7.

In another preferred embodiment of the invention, the construction material according to the invention is characterised in that it contains:

420-378 parts of water glass,
120-110 parts of water,
25-1 parts of fumed silica,
43-22 parts of ground sand, and
50-25 parts of post-industrial waste material L, P, R or mixtures thereof in any mass ratio of 8:1:1 through 1:8:1 to 1:1:8, preferably 6:2:7.
Preferably, the construction material according to the invention is characterised in that it consists of:
2.8 l (385 parts) of water glass
1.2 l (120 parts) of water,
50 g (5 parts) of fumed silica,
225 g (23 parts) of ground sand, and
250 g (25 parts) of post-industrial waste material L, P or R
Preferably, the construction material according to the invention is characterised in that it consists of:
2.9 l (420 parts) of water glass
1.1 l (110 parts) of water,
75 g (8 parts) of fumed silica,
425 g (43 parts) of ground sand, and
250 g (25 parts) of waste material L or mixture L, P and R at a mass ratio of 6:2:7.

Preferably, the construction material according to the invention contains water glass with a silicate modulus M=2.5-3.5 and density of 1.35-1.45 g/cm³, fumed (pyrogenic) silica having a specific surface of 300 to 380 m²/g with a content of SiO₂ of at least 80%, or amorphous fumed silica with a content of SiO₂ of at least 85% and bulk density of at most 150 g/dm³, and flotation tailings L or P, or R or a mixture thereof, wherein the respective constituents of the waste material are as follows:

“L” SiO₂ of 57.24%, CaO of 11.87%, MgO of 4.23%, Al₂O₃ of 4.17%;
“P” SiO₂ of 19.67%, CaO of 24.85%, MgO of 6.19%, Al₂O₃ of 3.25%;
“R” SiO₂ of 53.27%, CaO of 13.88%, MgO of 5.35%, Al₃O₃ of 3.84%.

Optionally, to the composition of the construction material according to the invention, boric acid H₃BO₃ in an amount of 1-5 g of the acid per 100 g of dust can be added. The addition of boric acid improves the homogeneity and porosity of the construction material according to the invention.

Another object of the invention is a method for preparing the construction material, characterised in that, to 420-378 parts of water glass, with continuous mechanical stirring, 110-120 parts of water and 25-1 parts of fumed silica with a content of SiO₂ of at least 80% and 43-22 parts of ground sand are added, and then 50-25 parts of post-industrial waste material L, P, R or a mixture thereof in any mass ratio of 8:1:1 through 1:8:1 to 1:1:8, preferably 6:2:7 are added, whereupon ingredients are mixed until the ingredients are completely distributed throughout the mixture and a homogeneous thick suspension is obtained, whereupon the suspension is dried at a temperature of 70-90° C. for a period of 2-4 hours until a sol or gel is obtained, and then a metal mold is filled and a thermal treatment is performed in a furnace to obtain, after the complete cooling down, the construction material in the shape determined by the mold.

The thermal treatment using the method according to the invention is conducted in a single step at a temperature of 350-600° C. for a period of 45 minutes to 3 hours or in several steps through heating of the mold to a temperature of 150° C. for a period of 60 min, and then further heating of the mold to a temperature of 250° C. for a period of 100 min and maintaining the mould at a temperature of 250° C. for 60 minutes, whereupon the mold is cooled down to room temperature within 120 minutes, where in further annealing is performed by heating the mold to a temperature of 400° C. to 500° C. for a period of 240 minutes, maintaining the mold at this temperature (400° C. to 500° C.) for 60 minutes, whereupon the mold is cooled down to room temperature within 240 minutes.

In case a gel is obtained, before filling the mold, the gel is subjected to mechanical comminution into pieces having the size of beans. In addition, before filling the mold with the comminuted gel, the mold is lined with chalk overlay paper, aluminium foil, or is covered with kaolin clay solution in order to prevent adherence of the mass to the walls of the mold and to facilitate removal of the finished material from the mold after the thermal treatment.

In the method according to the invention, the step of mixing the ingredients to obtain a homogeneous suspension allows an accurate dispersion of post-industrial waste material. The step of drying the suspension allows the dispersion to be maintained and thereby prevents possible stratification of the suspension, which affects the homogeneity of the construction material according to the invention. Furthermore, in case a gel is obtained, it can be subjected to further thermal treatment in order to obtain the construction material according to the invention or stored in gel form without the fear of stratification of the ingredients. In the step of annealing, the final form of the construction material according to the invention, in the shape determined by the shape of the mold, is obtained.

Due to the fact that the suspension subjected to annealing has the consistency of a sol or gel, it can easily fill the molds of different shapes (blocks, plates, discs, cylinders, tubes, cubes etc.), therefore the construction material according to the invention can have universal applications in the construction industry. The construction material according to the invention allows complete utilisation of flotation tailings and solves the problem of accumulated heaps of post-industrial waste. The thermal treatment during the manufacturing process of the construction material according to the invention allows removal of possibly present flammable and ecologically harmful components Therefore, the construction material according to the invention is environmentally neutral, and when in contact with a high temperature, it melts and turns into the glass. The construction material according to the invention also has very good thermal insulation properties, therefore it can be used as a safe and ecological material for the construction of houses, which, thanks to its excellent thermal insulation properties, does not require the use of additional insulation layers, e.g., of walls made thereof.

In addition, partial or complete substitution of ultra-dispersive fumed silica with post-industrial waste material L, P, R and with ground sand allows a significant reduction in costs of manufacturing the construction material according to the invention compared to conventionally used hollow blocks, and at the same time it allows a reduction of harmful effects from storing post-industrial waste materials L, P, R on the natural environment, and contributes to the increase of quality of life of people living near the heaps of post-industrial waste.

The invention is presented in detail in embodiments that do not limit its scope.

### EXAMPLE 1

To 2.8 l (385 parts) of water glass, with continuous mechanical stirring, 1.2 l of water (120 parts), 250 g of fumed silica (25 parts), 250 g of ground sand (25 parts) and 500 g of dried flotation tailings (50 parts) “L” with SiO₂ content of 57.24%, CaO of 11.87%, MgO of 4.23%, Al₂O₃ of 4.17% and 10 g of boric acid (1 part) were added. Then, the homogeneous thick mixture was dried at a temperature of 70° C. for 4 hours. After this time, a sol was obtained, with which a steel mold lined with chalk overlay paper was filled. The closed mold was placed in the furnace in which the temperature was raised at a speed of 10°/min. to a final temperature of 475° C. After reaching a temperature of 475° C. in the furnace, it was maintained for 2.5 hours, and then the furnace was turned off. A gradual cooling of the mold took place in the furnace. When completely cooled down, the construction material in the form of a block with dimensions of (60×320×320) mm was removed from the mold.

### EXAMPLE 2

To 2.8 l (385 parts) of water glass, with continuous mechanical stirring, 1.2 l (120 parts) of water, 150 g (15 parts) of fumed silica, 350 g (35 parts) of ground sand and 500 g (50 parts) of dried flotation tailings “P” with SiO₂ content of 19.67%, CaO of 24.85%, MgO of 6.19%, Al₂O₃ of 3.25% were added. Then, the homogeneous thick mixture was dried at a temperature of 90° C. for 2 hours. After this time, a gel was obtained. The gel was mechanically comminuted, and then the pieces having the size of beans were placed in a steel mold covered with aqueous solution of kaolin clay. The mold was placed in the furnace. The material was annealed in several steps. The first step—increase in temperature from room temperature to 150° C. lasted 1 hour. The second step—further increase to a temperature of 250° C. for another 100 minutes. Then, for 1 hour, the mold was maintained at 250° C., and for the next 2 hours, it was cooled down to room temperature. Subsequent steps consisted in increasing the temperature within 4 hours to 400° C. and in keeping the material at this temperature for another hour. The last step was a 4-hour cooling of the mold to room temperature.

When completely cooled down, the construction material in the form of a block with dimensions of (60×320×320) mm was removed from the mold.

### EXAMPLE 3

To 2.8 l (385 parts) of water glass, with continuous mechanical stirring, 1.2 l (120 parts) of water, 150 g (15 parts) of fumed silica, 350 g (35 parts) of ground sand and 250 g (25 parts) of dried flotation tailings “R” with SiO₂ content of 53.27%, CaO of 13.88%, MgO of 5.35%, Al₂O₃ of 3.84% were added. Then, the homogeneous thick mixture was dried at a temperature of 85° C. for 2.5 hours. After this time, a gel was obtained. The gel was mechanically comminuted into pieces having the size of beans, and then was placed in a steel mold covered with aqueous solution of kaolin clay. The mold was placed in the furnace. The temperature in the furnace was raised at a speed of 10°/min. to a temperature of 350° C. After reaching a temperature of 350° C. in the furnace, it was maintained for 2 hours, and then the furnace was turned off. A gradual cooling of the mold took place in the furnace. When completely cooled down, the construction material in the form of a block with dimensions of (60×320×320) mm was removed from the mold.

### EXAMPLE 4

To 2.9 l (420 parts) of water glass, with continuous mechanical stirring, 1.1 l (110 parts) of water, 75 g (8 parts) of fumed silica, 425 g (43 parts) of ground sand and 100 g (10 parts) of dried flotation tailings “L” with SiO₂ content of 57.24%, CaO of 11.87%, MgO of 4.23%, Al₂O₃ of 4.17%, 30 g (3 parts) of dried flotation tailings “R” with SiO₂ content of 53.27%, CaO of 13.88%, MgO of 5.35%, Al₂O₃ of 3.84% and 120 g (12 parts) of dried flotation tailings “P” with SiO₂ content of 19.67%, CaO of 24.85%, MgO of 6.19%, Al₂O₃ of 3.25% were added (in total 25 parts of waste L, P, R) Then, the homogeneous thick mixture was dried at a temperature of 90° C. for 2.5 hours. After this time, a gel was obtained. The gel was mechanically comminuted into pieces having the size of beans, and then was placed in a steel mold lined with chalk overlay paper. The mold was placed in the furnace. The temperature in the furnace was raised at a speed of 10°/min. to a temperature of 600° C. and was maintained for 45 min. A gradual cooling of the mold took place in the furnace. When completely cooled down, the construction material in the form of a block with dimensions of (60×320×320) mm was removed from the mold.

### EXAMPLE 5

To 2.8 l (385 parts) of water glass, with continuous mechanical stirring, 1.2 l (120 parts) of water, 75 g (8 parts) of fumed silica, 225 g (23 parts) of ground sand and 250 g (25 parts) of dried flotation tailings “R” with SiO₂ content of 53.27%, CaO of 13.88%, MgO of 5.35%, Al₂O₃ of 3.84% were added. Then, the homogeneous thick mixture was dried at a temperature of 80° C. for 2.5 hours. After this time, a thick sol was obtained, with which a steel mold lined with chalk overlay paper was filled. The mold was placed in the furnace. The temperature in the furnace was raised at a speed of 10°/min. to a temperature of 395° C. and was maintained for 2 h due to the thickness of the mold walls. A gradual cooling of the mold took place in the furnace. When completely cooled down, the construction material in the form of a block with dimensions of (60×320×320) mm was removed from the mold.

### EXAMPLE 6

To 2.8 l (386 parts) of water glass, with continuous mechanical stirring, 1.2 l (120 parts) of water, 50 g (5 parts) of fumed silica, 225 g (23 parts) of ground sand and 250 g (25 parts) of dried flotation tailings “L” with SiO₂ content of 57.24%, CaO of 11.87%, MgO of 4.23%, Al₂O₃ of 4.17% were added. Then, the homogeneous thick mixture was dried at a temperature of 90° C. for 2 hours. After this time, a gel was obtained. The gel was mechanically comminuted into pieces having the size of beans, and then was placed in a steel mold lined with aluminium foil. The mold was placed in the furnace. The temperature in the furnace was raised at a speed of 10°/min. to a temperature of 500° C. and was maintained for 2 h due to the thickness of the mold walls. A gradual cooling of the mold took place in the furnace. When completely cooled down, the construction material in the form of a block with dimensions of (60×320×320) mm was removed from the mold.

### EXAMPLE 7

To 2.8 l (378 parts) of water glass, with continuous mechanical stirring, 1.2 l (120 parts) of water, 10 g (1 part) of fumed silica, 350 g (350 parts) of ground sand and 250 g (250 parts) of dried flotation tailings “L” with SiO₂ content of 57.24%, CaO of 11.87%, MgO of 4.23%, Al₂O₃ of 4.17% were added. Then, the homogeneous thick mixture was placed in a steel mold the walls of which were protected against adhesion of aqueous solution of kaolin clay and was so placed in a furnace. In this case, the drying step was omitted. Initially, the temperature in the furnace was growing at a speed of 5°/min. to a temperature of 100° C. The mold was kept at this temperature for 1.5 to 2 h. Then, the temperature was raised at a speed of 10°/min. to a temperature of 475° C. and was maintained for 3 h due to the thickness of the mold walls. A gradual cooling of the mold took place in the furnace. When completely cooled down, the construction material in the form of a block with dimensions of (60×320×320) mm was removed from the mold.

### EXAMPLE 8

### Measurements of Thermal Conductivity Coefficient and Compressive Strength

### Reference Sample

To 3 l (411 parts) of water glass, with continuous mechanical stirring, 1.0 l (100 parts) of water and 260 g (26 parts) of ultra-dispersive fumed silica were added. Then, the mixture was dried at a temperature of 80° C. for 2 hours. After this time, the obtained sol was placed in a steel mold and placed in a furnace having a temperature of 450° C., where the mold was annealed for 2.5 h. A gradual cooling of the mold took place in the furnace. When completely cooled down, the construction material in the form of a block with dimensions of (60×320×320) mm was removed from the mold.

Measurements of thermal conductivity coefficient and compressive strength were conducted for the samples of Examples 1-7 and for the reference sample.

Measurements of thermal conductivity coefficient were conducted in the measuring device ITP MG4 100 in accordance with the Belarusian national standard GOST 7076-99 (comparable to the standard PN-EN 12667:2002). Compressive strength was measured in the laboratory of Wroclaw University of Technology in accordance with the standard PN-EN 826: 2013-07.

The results of compressive strength and thermal conductivity for the materials obtained are illustrated in the table below.

| | | Compressive | Thermal |
|---|---|---|---|
| | | strength | conductivity |
| No. | Sample | [MPa] | [W/m*K] |
| 1 | Example 1 | 0.85 | 0.071 |
| 2 | Example 2 | 0.71 | 0.076 |
| 3 | Example 3 | 0.68 | 0.071 |
| 4 | Example 4 | 1.25 | 0.088 |
| 5 | Example 5 | 0.76 | 0.071 |
| 6 | Example 6 | 1.11 | 0.061 |
| 7 | Example 7 | 0.67 | — |
| 8 | Reference (pure sample) | 0.25 | 0.044 |

### CONCLUSIONS

Results of compressive strength and thermal conductivity for construction materials according to the invention allow for the inclusion of these materials to the class of thermal insulation materials (according to the standard PN-EN 13167:2013-05E: λ<0.065).

The combination of the characteristics of low thermal conductivity and good mechanical parameters makes the material according to the invention appropriate to successfully substitute Ytong blocks traditionally used in the construction industry (CS 2 MPa, λ=0.095 W/m*K).

1-8. (canceled)

9. A construction material containing water glass, fumed silica, ground sand and post-industrial waste material, wherein the post-industrial waste material constitutes dried flotation tailings with a content of 19.67-57.24% of SiO₂; 11.87-24.85% of CaO; 4.23-6.19% of MgO and 2.35-4.17% of Al₂O₃.

10. The construction material according to claim 9, wherein the post-industrial waste material is constituted by waste L with a content of SiO₂ of 57.24%, CaO of 11.87%, MgO of 4.23%, Al₂O₃ of 4.17%; or P with a content of SiO₂ of 19.67%, CaO of 24.85%, MgO of 6.19%, Al₂O₃ of 3.25%, or R with a content of SiO₂ of 53.27%, CaO of 13.88%, MgO of 5.35%, Al₂O₃ of 3.84% or a mixture thereof at a mass ratio of 8:1:1 through 1:8:1 to 1:1:8, preferably 6:2:7.

11. The construction material according to claim 9, wherein it contains
a) 420-378 parts of water glass,
b) 110-120 parts of water,
c) 25-1 parts of fumed silica,
d) 43-22 parts of ground sand, and
e) 50-25 parts of post-industrial waste material L, P, R or mixtures thereof in a mass ratio of 8:1:1 through 1:8:1 to 1:1:8, preferably 6:2:7.

12. The construction material according to claim 9, wherein it contains an addition of boric acid H₃BO₃ in an amount of 1-5 g of the acid per 100 g of post-industrial waste material L, P, R or a mixture thereof.

13. The construction material according to claim 11, wherein it consists of 2.8 l of water glass; 1.2 l of water; 225 g of ground sand; 50 g of fumed silica and 250 g of flotation dusts L or P, or R.

14. The construction material according to claim 11, wherein it consists of 2.9 l of water glass; 1.1 l of water (110 parts); 75 g of fumed silica (8 parts); 425 g of ground sand (43 parts) and 250 g (25 parts) of waste material L or a mixture of L, P and R in a mass ratio of 6:2:7.

15. A method for preparing the construction material, wherein to 420-378 parts of water glass, 110-120 parts of water and 25-1 parts of fumed silica with a content of SiO₂ of at least 80% and 43-22 parts of ground sand are added, and then 50-25 parts of post-industrial waste material L, P, R or a mixture thereof in any mass ratio of 8:1:1 through 1:8:1 to 1:1:8, preferably 6:2:7 are added, whereupon the ingredients are mixed until a homogeneous thick suspension is obtained, whereupon the suspension is dried at a temperature of 70-90° C. for a period of 2-4 hours until a sol or gel is obtained, and then a steel mold is filled and a thermal treatment is performed in a furnace to obtain, after the complete cooling down, the construction material in the shape determined by the mold, whereupon the thermal treatment is conducted in a single step at a temperature of 350-600° C. for a period of 45 minutes to 3 hours or in several steps through heating of the mold to a temperature of 150° C. for a period of 60 min, and then further heating of the mold to a temperature of 250° C. for a period of 100 min and maintaining the mold at a temperature of 250° C. for 60 minutes, whereupon the mold is cooled down to room temperature within 120 minutes, wherein further annealing is performed by heating the mold to a temperature of 400° C. to 500° C. for a period of 240 minutes, maintaining the mold at this temperature (400° C. to 500° C.) for 60 minutes, whereupon the mold is cooled down to room temperature within 240 minutes.

16. The method according to claim 15, wherein the gel obtained after drying of the thick suspension is subjected to mechanical comminution into pieces having the size of beans, and before placing the comminuted gel in the mold, the mold is lined with chalk overlay paper, aluminium foil, or is covered with kaolin clay solution.
